(19) United States
(12) Patent Application Publication
(10) Pub. No.: US 2024/0345911 A1
(43) Pub. Date: Oct. 17, 2024

(54) MACHINE LEARNING AIDED DIAGNOSIS AND PROGNOSIS OF LARGE SCALE DISTRIBUTED SYSTEMS

(71) Applicant: MICROSOFT TECHNOLOGY LICENSING, LLC, Redmond, WA (US)

(72) Inventors: Ravi Teja BELLAM, Redmond, WA (US); Rohith Reddy GUNDREDDY, Redmond, WA (US); Woo Sik KIM, Redmond, WA (US); Vineeth THAYANITHI, Naperville, IL (US); Neil Patrick GOMPF, Redmond, WA (US); Arup ARCALGUD, Redmond, WA (US); Gurpreet SOHAL, Seattle, WA (US)

(21) Appl. No.: 18/227,877

(22) Filed: Jul. 28, 2023

Related U.S. Application Data
(60) Provisional application No. 63/459,567, filed on Apr. 14, 2023.

(51) Int. Cl. G06F 11/07; G06N 20/00

(52) U.S. Cl. CPC G06F 11/079; G06F 11/0709; G06N 20/00

(57) ABSTRACT

Disclosed is a system for providing machine learning aided diagnostics and prognostics for large distributed systems. A diagnostics module applies two-tiered analysis to detect anomalous behavior of the large scale distributed system. First, multivariate telemetry and event data emitted from the large scale distributed systems is collected by a diagnostics component, which applies multivariate analysis to identify of set of N-anomalies. Second, univariate telemetry and event data is obtained by the diagnostics component, which applies univariate analysis to the N-anomalies previously identified, ranks the results, and provides them to an AI to generate a diagnostics incident report. A prognostics module reviews the diagnostics incident report and maps each identified issue to a resolution plan. If execution of the resolution plan does not succeed in resolving the identified issue, the issue is escalated to a support team. The disclosed techniques may predict and prevent issues, or drastically reduce resolution time.

### CROSS-REFERENCE TO RELATED APPLICATIONS

The present application is a non-provisional application of, and claims priority to, U.S. Provisional Application Ser. No. 63/459,567 filed on Apr. 14, 2023, the contents of which are hereby incorporated by reference in their entirety.

### BACKGROUND

Artificial intelligence (AI) has a rich history, dating back to the mid-20th century when pioneers like John McCarthy and Marvin Minsky first began exploring the concepts. Initially, AI was seen as a way to replicate human intelligence in machines, and early efforts focused on developing systems that could perform tasks like playing chess or proving mathematical theorems.

Over the years, AI has evolved and expanded its focus to include a wide range of applications, from image recognition to natural language processing (NLP). Various AI systems and methods may now be applied in numerous domains.

Large language models (LLMs) are a recent development in the field of NLP. LLMs can apply deep learning algorithms, sometimes referred to as machine learning (ML), to leverage massive amounts of data, which can result in highly accurate language processing capabilities. Some example LLMs include GPT-3 and BERT, which are trained on vast amounts of text data, allowing them to model complex relationships in language and highly accurate predictions for a wide range of language tasks such as: translation, summarization, and responses to questions. This has led to breakthroughs in areas like chatbots, virtual assistants, and language-based recommendation systems.

Overall, ML and LLM represent significant steps forward in the field of AI, which show great potential to revolutionize the way we interact with machines. These AI systems can be extended via custom integration with other services and interfaces to provide robust applications. It is with respect to these and other considerations that the disclosure made herein is presented.

### SUMMARY

Disclosed is a system for providing machine learning aided diagnostics and prognostics for large distributed systems. A diagnostics module applies two-tiered analysis to detect anomalous behavior of the large scale distributed system. First, multivariate telemetry and event data emitted from the large scale distributed systems is collected by a diagnostics component, which applies multivariate analysis to identify of set of N-anomalies. Second, univariate telemetry and event data is obtained by the diagnostics component, which applies univariate analysis to the N-anomalies previously identified, ranks the results, and provides them to an AI to generate a diagnostics incident report. A prognostics module reviews the diagnostics incident report and maps each identified issue to a resolution plan. If execution of the resolution plan does not succeed in resolving the identified issue, the issue is escalated to a support team. The disclosed techniques may predict and prevent issues, or drastically reduce resolution time.

In some embodiments, a method for a machine learning (ML) based artificial intelligence (AI) support system to service a large scale distributed system is described, the method comprising: collecting multivariate telemetry and event data by a diagnostics component of the support system; analyzing the multivariate telemetry and event data by multivariate analysis to identify a set of N-anomalies with the diagnostics component of the support system; for each of the set of N-anomalies: obtaining unaggregated univariate telemetry and event data by the diagnostics component of the support system; and analyzing the unaggregated univariate telemetry and event data by univariate analysis by the diagnostics component of the support system; ranking the diagnostic results of the univariate analysis by the diagnostics component of the support system; and providing the diagnostic results and rankings to the machine learning (ML) based artificial intelligence (AI) support system to generate a diagnostic incident report.

In some additional embodiments, a computer-readable storage medium is described having computer-executable instructions stored thereupon that, when executed by one or more processing units of a machine learning based artificial intelligence support system to service a large scale distributed system, cause the AI support system to: collect multivariate telemetry and event data by a diagnostics component of the support system; analyze the multivariate telemetry and event data by multivariate analysis to identify a set of N-anomalies with the diagnostics component of the support system; for each of the set of N-anomalies: obtain unaggregated univariate telemetry and event data by the diagnostics component of the support system; and analyze the unaggregated univariate telemetry and event data by univariate analysis by the diagnostics component of the support system; rank the diagnostic results of the univariate analysis by the diagnostics component of the support system; and provide the diagnostic results and rankings to the machine learning (ML) based artificial intelligence (AI) support system to generate a diagnostic incident report.

In still other embodiments, a machine learning (ML) based AI support system to service a large scale distributed system is described, the AI support system comprising: a processor; and a computer-readable storage medium having computer-executable instructions stored thereupon that, when executed by the processor, cause the AI support system to: collect multivariate telemetry and event data by a diagnostics component of the support system; analyze the multivariate telemetry and event data by multivariate analysis to identify a set of N-anomalies with the diagnostics component of the support system; for each of the set of N-anomalies: obtain unaggregated univariate telemetry and event data by the diagnostics component of the support system; and analyze the unaggregated univariate telemetry and event data by univariate analysis by the diagnostics component of the support system; rank the diagnostic results of the univariate analysis by the diagnostics component of the support system; and provide the diagnostic results and rankings to the machine learning (ML) based artificial intelligence (AI) support system to generate a diagnostic incident report.

Various technical differences and benefits are achieved by the described systems and methods. For example, the presently described systems and methods use a multi-tiered approach that segments diagnostic analysis into two phases: first a multivariate analysis and second a univariate that leverages the results of the multivariate analysis. This two-step approach reduces the amount of calculation time required to assess and identify possible root level causes, which saves time, operational cycles, and money. In some examples, the presently disclosed system use multivariate analysis of aggregated telemetry and event data, which reduces the amount of calculation time required to find an initial assessment of root level cause. The univariate analysis is performed on disaggregated telemetry and event data, which can be more deeply analyzed, to improve granularity in possible root-cause solutions. Metrics, logs and change events can be leveraged as telemetry and event data, which improves root-cause solutions by providing detailed information for analysis by the ML based diagnostics. The two tiered approach also takes a whole system approach first, which leverages ML diagnostics to enable root-cause diagnostics without requiring human users to set the conditions for data mining and monitoring.

In AI systems, such as LLM and ML based systems, the applicability domain refers to the range of inputs or situations in which a model is expected to perform well. The applicability domain can be influenced by factors such as the quality and quantity of data available, the complexity of the problem, the algorithms and models used by the AI system, and the level of human intervention and oversight. The applicability domain may also identify scenarios where the model's predictions are reliable and accurate, as well as scenarios where the model may struggle to deliver accurate results. Understanding the applicability domain is critical for AI practitioners and users, as it can help to identify potential risks and limitations of the model, and ensure that it is only used in scenarios where it is most effective. The presently described techniques have applicability over multiple domains, including but not limited to, distributed system maintenance, healthcare, manufacturing, logistics, supply chain management, energy management, financial investments, to name a few.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), component(s), algorithm(s), hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates an example system that is capable of implementing aspects of the techniques and technologies presented herein.

FIG. 2 illustrates another example system that is capable of implementing aspects of the techniques and technologies presented herein.

FIG. 3 is an example flow diagram for a diagnostics module of an example system, in accordance with various aspects described herein.

FIG. 4 is another example flow diagram for a diagnostics module of an example system, in accordance with various aspects described herein.

FIG. 5 is a graph demonstrating various aspects of aggregated time-series employed by example diagnostics modules, in accordance with various aspects described herein.

FIG. 6 is an example flow diagram for a prognostics module of an example system, in accordance with various aspects described herein.

FIG. 7 is a computer architecture diagram illustrating an illustrative computer hardware and software architecture for a computing system capable of implementing aspects of the techniques and technologies presented herein.

FIG. 8 is a diagram illustrating a distributed computing environment capable of implementing aspects of the techniques and technologies presented herein.

FIG. 9 is a graph demonstrating various aspects of time-series metrics employed in training an ML system, in accordance with various aspects described herein.

FIG. 10 is a graph demonstrating various aspects anomalies with root causes identified by a trained ML system, in accordance with various aspects described herein.

### DETAILED DESCRIPTION

Use of large-scale distributed systems are exponentially evolving, growing more complex by the day. Today, organizations are reactive to security & reliability incidents, which causes loss of customer trust, impact to revenue, and burn-out of employees that manually deal with such incidents. The current practice of reactive system maintenance and troubleshooting does not scale well, which influences how quickly organizations can deliver quality products to the customers. The present disclosure identifies solutions to reactive system maintenance and troubleshooting by leveraging machine learning (ML) systems, methods, and other techniques to aid in diagnosis and prognosis of large scale distributed systems using telemetry and event data.

In accordance with the present disclosure, a diagnostics module in a support system may operate with the aid of a ML based module or system for fault detection and root cause determinations using telemetry data from multiple sources including distributed systems time series-based metrics, logs and change events. Based on the detected faults and determined root causes from the diagnostics module, a prognostics module may assist with the recovery from faults with its recommendations. The disclosed diagnostics module may significantly reduce the Mean Time to Resolve (MTTR) by reducing Time to Detect (TTD), Time to Mitigate (TTM), scaling the engineering operations, predict and prevent the issues, which may also drastically reduce support costs to be providers and customers. The diagnostic module leverages breaks the problem into multivariate analysis and univariate, where the univariate analysis results of the multivariate analysis, whereby efficiencies are improved and calculation times are reduced in assessing and identifying possible root level causes. The described solutions improve accuracy with reduced processing time and reduced errors, where root-cause diagnostics are achieved without requiring human users to set the conditions for data mining and monitoring.

### General Problem Overview

Cloud services such as Microsoft Azure offer modern technologies that allow businesses of all sizes to accelerate their digital transformation to achieve improved services and cost savings. The complexity of managing the software and hardware environments is transferred from these businesses to the organizations that offer these cloud services. Cloud services and platforms that power these services are required to be updated frequently, while expected to deliver the highest level of quality, performance, availability, security, and reliability. Service availability and performance could be impacted by either a direct or dependency related change. The availability and performance impacts caused by service degradation (unavailability, congestion), inability to handle traffic spikes, and cascading failures my lead to major incidents or outages resulting in loss of customer trust, loss of revenue in millions and burn out of employees. Currently, incident handling typically happens based on domain knowledge and human experience, which introduces delays in resolving the incidents or outages especially when multiple teams need to be involved for resolution. However, the present solution leverages ML based AI support component to augment the process to quickly detect and root cause problems identified within a large distributed system. This approach not only achieves quick resolution, but also helps to scale operations, and also can predict and prevent outages from happening.

### Diagnostics & Prognostics Systems Overview

With the overarching goal of proactively preventing security and reliability issues from reaching production, one goal is to build an intelligent service that is capable of analyzing large volumes of data that are emitted from a system. Data can then be correlated to identify problems, and a comprehensive assessment of the health of a service may be made, with identification of possible solutions and recommendations. Diagnostics & Prognostics focuses on understanding, modeling, and reasoning with a variety of data emitted by the cloud platforms and services. Diagnostics can further explorer advances in AI and ML within the area of Anomaly Detection and apply on to the different sources of data to detect the faults. Due to the complexity of the cloud platforms with thousands of nodes serving computing, networking, storage and authentication workloads and hundreds of services interacting with each other and ever-increasing scale pose significant challenges for the engineers to efficiently respond to the faults unless the root of the faults can be provided in a timely manner.

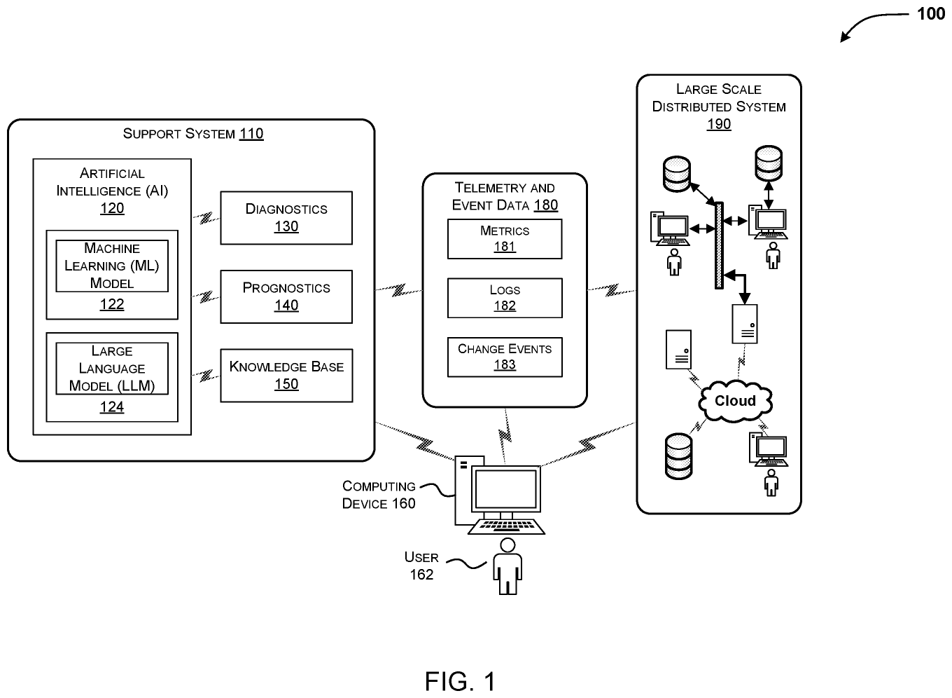

FIG. 1 illustrates an example system 100 that is capable of implementing aspects of the techniques and technologies presented herein. As illustrated, the system 100 may include a support system 110, which includes an artificial intelligence (AI) system or component 120, a diagnostics component 130, a prognostics component 140, and a knowledge base 150.

The support system 110 can be interfaced to a large scale distributed system 190, and also to a user 162 via a computing device 160, which may be a support team member such as an engineer that may need to service the large scale distributed system 190. The AI system or component 120 may include a machine learning (ML) model 122 and/or a large language model (LLM) 124, as well as other skills and resources. AI component 120 is interfaced to the diagnostics component 130, the prognostics component 140, and the knowledge base 150.

User 162 may operate computing device 160 to navigate a browser to communicate with various tools needed to access the support system 110. In some examples, the user 162 may access a browser to locate monitoring tools, which may monitor system performance and resources used by the large scale distributed system 190. In some additional examples, the user 162 may communicate with the support system via a chatbot type of website that may utilize a natural language model (NLM) interface to interact with users in a human-like way. The AI system or component 120 may be located in a cloud resource, such as on a remote computing device, although it may alternatively be implemented resident on computing device 160.

The AI system or component (or module) 120 may use various natural language processing (NLP) techniques to determine context around keywords and phrases in the text data. One techniques, called contextual word embeddings, represents each word found in a text prompt as a dense, low-dimensional vector that captures meaning in the context of the surrounding words by applying deep learning models, such as using a machine learning model (ML) 122. The LLM 124 in the present AI component 120 can thus be trained on large amounts of text data to learn the patterns and relationships between words and phrases in different contexts. When processing a piece of text data, words and phrases can be context related to their closely related target keyword or phrase in their embeddings by the LLM 124.

The large scale distributed system 190 may include a variety physical and virtual system components, including but not limited to, networking, computing, or data storage resources. Example networking resources in system 190 may include any variety of servers, routers, switches, network controllers, wi-fi access points, including cloud based resources. Example computing resources may include or memory, processors such as CPUs or graphics accelerators, either virtual or physical. Data storage resources may include virtual or physical disk storage, data-base storage, or the like. Users in geographically disparate locations may access system 190 using computing devices such as computing device 160, or cell phones, set-top boxes, tablet computers, etc. Large scale distributed systems may generally be considered as complex computer networks with a large number of distributed resources. Examples of large scale distributed systems may include financial or banking systems, global e-commerce platforms, large scale industrial processes, health care insurance processing systems, to name a few

Operationally, large scale distributed systems such as system 190 emit telemetry and event data 180, typically in very large volumes. The telemetry and event data 180 may consist of any variety of metrics 181, logs 182 or change events 183.

Metrics 181 may include any variety of monitored resources or performance. The specific set of metrics used for anomaly detection may vary depending on the architecture of the large scale distributed system 190, as well as any specific applications and operational conditions for the system. Example metrics 181 may include type of measurable resource usage, including but not limited to disk usage, CPU usage, memory usage, network usage, system load, latency, failure count, error rate, user activity, timing measurements, or health status of system components, temperature of components, etc. These metrics may be provided as a stream of system related measurements over time, which may be represented as a time-series. To define expected or normal behavior of these metrics may require specific domain expertise as well as baseline measurements of metrics over a variety of operating conditions and time frames. Ranges of expected operation can thus be a dynamically changing value based on time, and setting appropriate thresholds or rules to detect anomalies can be highly complex.

Logs 182 may include any variety of log file or message that may be created to record events or activities that are generated by the large scale distributed system 190. Example logs 182 may, including but are not limited to system logs, console logs, server logs, security or fraud detection logs, performance logs, application logs, or database logs, which may include various text based descriptors such as a log type, name, time-stamp, variables, and other indicia of the logged event. Logs may be generally manifested as error messages, warning messages, or information messages. System logs may be stored in a dedicated location as a file, which can be used for troubleshooting, monitoring, and auditing purposes. Similar to the metrics described above, expected operation of a system can be analyzed by various methods that consider logs that violate expected criteria based on trends or log pattern changes that may occur over time, which can thus be a dynamically changing criteria, where setting appropriate thresholds or rules to detect anomalies in logs can be highly complex.

Change events 183 may occur when there is a modification or update to a particular entity, component, or resource within a large scale distributed system or within an application. A change events may capture detailed information about what has changed in the system, when the change occurred, and who made the change. Change events can be triggered by user interactions, system processes, or external events, and they also may be used to track modifications to configuration settings. Systems may also employ version control logging, as well a other configuration management techniques to maintain audit trails to track changes. Each of these types of emitted telemetry and event data 180 can be represented as a time-series or stream that exhibits changes over time. Deep analysis of change events can be employed to identify possible root causes of anomalies that occur in a system, but domain specific knowledge may be needed to understand which changes are most relevant to a given problem.

When an anomaly occurs in large scale system 190, some amount of information about the anomaly can be surmised by a deep knowledge of normal (i.e., non-anomalous) behavior of the system and analysis of emitted telemetry and event data 180. For example, during normal operation, data streams for monitored system resources such as CPU, disk or memory usage may be within an expected range of values; log files may indicate expected system transaction, and events are all within the bounds of normal operation. However, when an anomaly occurs in the system, these metrics, logs and change events may fall outside of the expected operation ranges for a prolonged period of time.

A key issue with detection of anomalies is understanding the domain and context of expected operation. In one example, an online sales website may be expected to have very heavy traffic during a promoted or seasonal sales event, where an anomaly could be detected when very low traffic is detected (e.g., low number of users logging in and out of the site, low disk usage, low volume of sales, etc.). In another example, a security system may be expected to monitor a massive number of users and their activities on a large scale financial system, where an anomaly may be detected when there are sudden spikes in large data transfers occurring over a series of ports using unusual protocols based on patterns of typical users.

Deep analysis of the specific domain may thus be required to understand the context of expected behavior criteria and anomalous behavior for any given large scale distributed system. Massive amounts of data may be generated, making it challenging or impossible to detect anomalies manually. Anomaly detection in such a large-scale system may thus be considered as a process of identifying unusual or unexpected events or patterns within a large dataset from the emitted information from the system. As described herein, the anomaly detection techniques leverage machine learning algorithms to automatically identify patterns that deviate significantly from the normal behavior of the system.

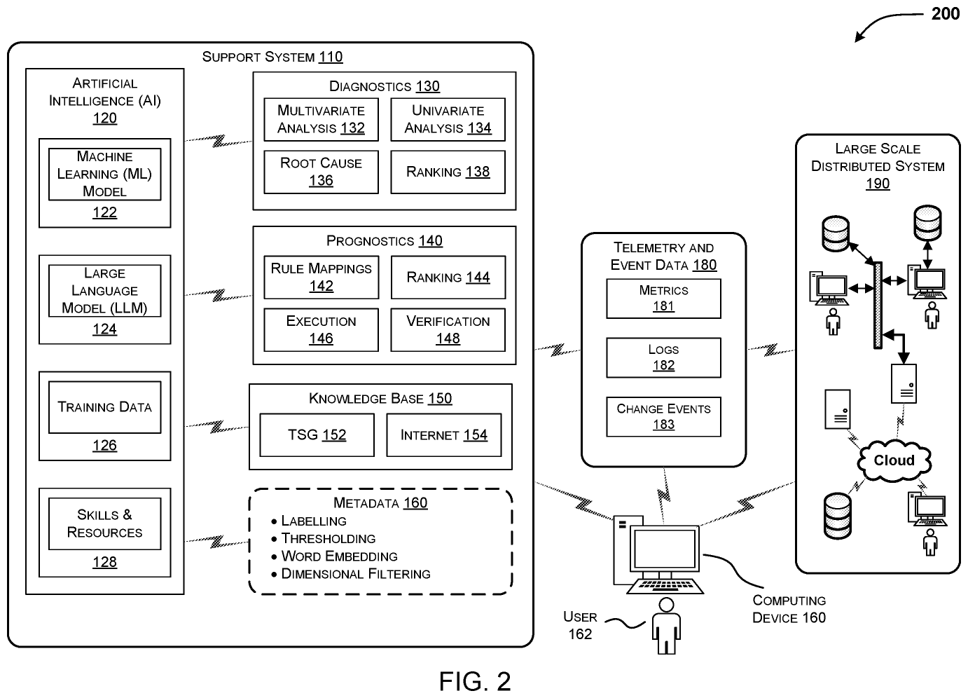

FIG. 2 illustrates another example system 200 that is capable of implementing aspects of the techniques and technologies presented herein. As illustrated, the system 200 may again include a support system 110, which includes an artificial intelligence (AI) system 120, a diagnostics component 130, a prognostics component 140, and a knowledge base 150.

Similar to system 100 of FIG. 1, system 200 may include a support system 110 that can be interfaced to a large scale distributed system 190, and also to a user 162 via a computing device 160, which may be a support team member such as an engineer that may need to service the large scale distributed system 190. The AI system or component 120 may include a machine learning (ML) model 122, a large language model (LLM) 124, training data 126, as well as other skills and resources 128. The AI component can leverage the skills and resources 128 to accomplish tasks. Example skills and resources include, but are not limited to, registered functions, application program interfaces to external resources (APIs) and internal resources (local APIs), databases, web searches, email, and many other resources. AI component 120 can be interfaced to the diagnostics component 130, the prognostics component 140, the knowledge base 150, and also may leverage metadata 160 during training as will be further described below.

### Diagnostics

For FIG. 2, the diagnostic component or module 130 further includes functional blocks for multivariate analysis 132, univariate analysis 134, root cause analysis 136, and ranking 138. These functions may be leveraged to continuously monitor, detect, and generate alerts for anomalies (e.g., system faults errors, etc.) and their causes that arise in the large scale distributed system 190. Additionally, the diagnostics component 130 is shown in communication with AI component 120, which enables the diagnostics to take advantage of recent advances in ML to find improvements in detection and prediction of anomalies.

Within the subject area of anomaly detection, most methods can be categorized as either univariate analysis or multivariate analysis. Univariate analysis refers to analysis of a single time-series metric, variable, or signal; while multivariate analysis refers to analysis of a combination of multiple time-series values. While univariate time-series anomaly detection allows for the detection issues within very specific, individual component or subcomponents of a large scale system, such univariate analysis is very granular by its nature since it looks deeply at each specific time-series. In order to detect an anomaly, a large number of individual univariate analysis may need to be completed, which thus may be too slow and inefficient for rapid detection and resolution. Additionally, univariate analysis may fail to capture system-wide or ecosystem-wide issues in a time-efficient manner.

In the presently described solution, multivariate-anomaly detection is leveraged as a firm starting point for anomaly detection. In contrast to univariate analysis, multivariate analysis can evaluate multiple variables or factors simultaneously. Although the individual system components are not directly evaluated, multivariate analysis can explore the relationship between various system components and interactions, where patterns and trends for system components and system variables may emerge, enabling predictions and/or inferences. A more comprehensive and sophisticated analysis of complex data sets can be rapidly made by the described techniques.

A multivariate time series is a collection of individual time series data. The diagnostic module or component 130 handles anomaly detection by continuously monitoring a services core time series data collectively as a group or cluster. The multivariate time-series can be considered as a graph attention network model, which may be able to outperform forecasting models such as LSTMs and reconstruction-based models such as encoder-decoders. Multivariate data is aggregated into groups or clusters, where each group or cluster may correspond to a common criteria. In one example, each group or cluster corresponds to a location dimension, and a model for the location of the services is maintained and tracked for ML training purposes, as well as for detection purposes. In various examples, it has been observed that the behavior of each location may be different from one another.

Diagnostics component 130 leverages multi-tiered anomaly detection that uses a combination of multivariate analysis 132 and univariate analysis 134 models to detect abnormalities within the system and determine root causes 136. The first level of anomaly detection determines if an anomaly is present within the system by analyzing all the service level indicator metrics as a whole and if there exists an anomaly with the most-likely root causes. Once the most likely root causes are obtained, univariate analysis is leveraged as a second level of anomaly detection, which is on the more granular level of metrics that contributed to the most-likely root causes.

The unaggregated time series of the metrics are obtained for univariate analysis, resulting in thousands of time series for analysis. An individual anomaly detection request can be created for each of these unaggregated time series, for example, utilizing univariate spectral residual anomaly detection methods, such as scalable Azure functions services and infrastructure. This second step finally results in the most anomalous unaggregated metrics from the most likely root cause metrics obtained in the first step. This insight is key for service engineers or support team members to be able to detect and resolve anomalies with all of the relevant information on hand.

By having this described multi-tiered system anomaly detection methodology, the likelihood of finding anomalies and their root causes within a large complex system is vastly improved, while also eliminating the analysis cycles that would otherwise be required to run anomaly detection on millions of time series for every minute. Overall, computational requirements are drastically reduced, conserving power, improving detection time, accuracy, and saving costs. A deep dive univariate analysis would not be necessary but for the most extreme abnormal states that are well outside of expected conditions. Instead, the presently described system can rely on the multivariate detection model to successfully detect most of the system abnormalities.

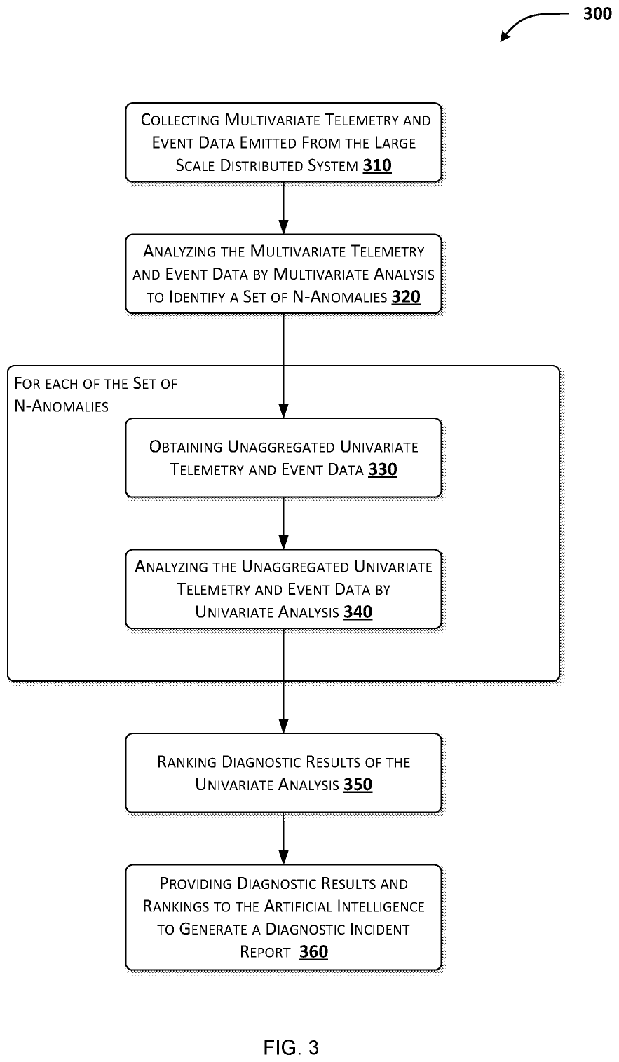

FIG. 3 is an example flow diagram 300 for a diagnostics module 130 of an example system (e.g., 100, 200, etc.), arranged in accordance with various aspects described herein. The flow diagram 300 may be broken into various blocks or partitions, such as blocks 310, 320, 330, 340, 350 and 360, as illustrated. Processing for the various blocks of flow diagram 300, which may be described as processes, methods, steps, or functions, may commence at block 310.

At block 310, “Collecting Multivariate Telemetry and Event Data Emitted From the Large Scale Distributed System”, multivariate telemetry and event data (180) is collected from the large scale distributed system (190). The multivariate telemetry and event data (180) may comprise one or more of: performance metrics associated with the large scale distributed system, logs associated with the large scale distributed system, and change events associated with the large scale distributed system, as previously described above. Processing may continue from block 310 to block 320.

At block 320, “Analyzing the Multivariate Telemetry and Event Data by Multivariate Analysis to Identify a Set of N-Anomalies”, the multivariate telemetry and event data collected at block 310 may be analyzed to identify a set of N-anomalies. This multivariate analysis may use a graph attention based deep learning network model that leverages the ML aspects of the trained AI component 110. The multivariate anomaly detection model is trained on the normal behavior of the telemetry and event data, such as from based on the “Normal” or “Expected” behavior of a large scale distributed system 190. Block 320 may thus serve as a first level of anomaly detection to determine if an anomaly (or a set of N-anomalies) is present within the system by analyzing all the telemetry and event data 180 as a whole, and in real time. Processing from block 320 may be followed by block 330.

At block 330, “Obtaining Unaggregated Univariate Telemetry and Event Data”, the unaggregated univariate telemetry and event data 180 for each of the identified anomalies from bock 320 (e.g., N-anomalies) are obtained. The univariate data can be obtained by any appropriate method that is keyed from the set of N-anomalies, such as from a data service or data layer in the system (e.g., 100, 200). Each of the univariate data may be comprised of a time-series for individual metrics, individual logs, or individual change events, as previously described. The various time series to be obtained may be large (e.g., in the thousands). Processing for block 330 may be followed by block 340.

At block 340, “Analyzing the Unaggregated Univariate Telemetry and Event Data by Univariate Analysis”, the unaggregated univariate telemetry and event data 180 obtained at block 330 is analyzed using univariate analysis methods. Individual anomaly detection requests can be created and sent to the ML based system for each of these time series utilizing univariate spectral residual anomaly detection methods, such as in scalable Azure functions. This finally results in the most anomalous unaggregated metrics from the most likely root cause metrics obtained from the first step of multivariate anomaly detection, which is a key insight to resolving the anomaly. Block 340 may thus serve as a second step of univariate anomaly detection, which is on the more granular level of metrics that contributed to the most-likely root causes. By having this multi-tiered system as described here, the need to run anomaly detection on millions of time series every few minutes is eliminated, thereby drastically reducing the compute power needed. A deep dive is only necessary when the system is in an abnormal state, and we can rely on the multivariate detection model to identify these system abnormalities. Block 340 may be followed by block 350.

At block 350, “Ranking Diagnostic Results of the Univariate Analysis”, the diagnostic results output from the univariate analysis are ranked. The ranking of the diagnostic results can be according to any desired criteria. In one example, the ranking may be from highest level system failure to lowest level system failure. In another example, the ranking may be from most imminent danger of failure to least imminent danger of failure. In still another example, the ranking may be from highest confidence rating in root cause to lowest confidence rating in root cause. The criteria for ranking can be embodied in many other examples, and these are considered non-limiting examples. Processing from Block 350 may be followed by block 360.

At block 360, “Providing Diagnostic Results and Rankings to the Artificial Intelligence to Generate a Diagnostic Incident Report”, the final diagnostic results along with the ranks are provided to the AI so that the AI support component can generate a complete diagnostic incident report. The diagnostic incident report may be processed with the large language model (LLM) of the AI support component to ensure complete and robust descriptions are provided. Thus, block 360 may be broken into two or more steps of: “providing the diagnostic results and rankings to a machine learning (ML) based artificial intelligence (AI) support component”, “responsively generating a diagnostic incident report with the ML based AI support component”, and “receiving a diagnostic incident report from the ML based AI support component.” Additionally, the support system may coordinate communications to other modules or components for tracking and auditing purposes, as well as communications to support service teams as may be required.

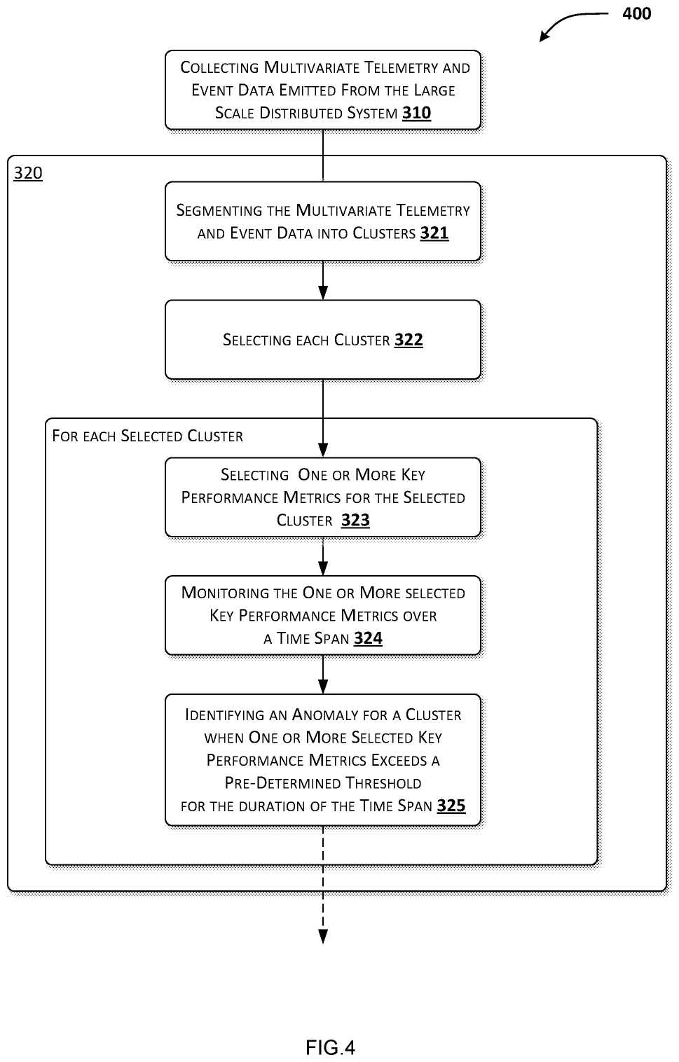

FIG. 4 is another example flow diagram 400 for a diagnostics module 130 of an example system (e.g., 100, 200), arranged in accordance with various aspects described herein. The flow diagram 400 may be broken into various blocks or partitions, such as blocks 310 and 320, as illustrated. Processing for the various blocks of flow diagram 400, which may be described as processes, methods, steps, or functions, may commence at block 310, similar to FIG. 3. However, block 320 includes additional details as shown by additional blocks 321, 322, 323, 324 and 325

At block 321, “Segmenting the Multivariate Telemetry and Event Data into Clusters”, the various multivariate telemetry and event data collected from block 310 are organized into clusters that adhere to a common criteria. For example, as previously discussed herein, the diagnostic module 130 handles anomaly detection by continuously monitoring a services core time series data collectively as a group or cluster. Thus, the multivariate data is aggregated into groups or clusters, where each group or cluster may correspond to a common criteria. In one example, each group or cluster corresponds to a location dimension, and a model for the location of the services is maintained and tracked for ML training purposes, as well as for detection purposes. Processing may continue from block 321 to block 322.

At block 322, “Selecting each Cluster”, each of the clusters are selected for processing. In one example, an iterative loop such as a for loop (e.g., for each selected cluster . . . ) may be used to process each of the clusters one at a time. In other examples, one or more of the clusters may be processed in parallel with one another. In another example, one or more of the clusters are sent to a service handler for processing. These are merely non-limiting examples, and other possibilities for handling the selection and processing of clusters are contemplated. Block 322 is followed by block 323.

At block 323, “Selecting One or More Key Performance Metrics for the Selected Cluster”, one or more key performance metrics may be selected to be monitored for the currently selected one of the multivariate clusters. For example, “CPU utilization” may be selected as a key performance metric for a cluster of system resources that is associated with a geographic region of “East US”. In another example, “Failed User Login Attempts” may be selected as a key performance metric for a cluster of resources that is associated with “Home Office.” Although described with respect to key performance metrics, these examples also apply to logs and change event tracking. Block 323 may be followed by block 324.

At block 324, “Monitoring the One or More selected Key Performance Metrics over a Time Span”, the various selected key performance metrics from block 324 are monitored over a time span to determine if the performance metrics are within expected ranges of operation for normal operation. Block 324 may be followed by block 325.

At block 325, “Identifying an Anomaly for a Cluster when One or More Selected Key Performance Metrics Exceeds a Pre-Determined Threshold for the duration of the Time Span”, the diagnostics module or component can determine if an anomaly is detected when the monitored performance metrics exceed thresholds associated with the normal ranges of operation for the system. In one example, one or more selected key performance metrics may exceed an upper threshold for a duration of the time span which is detected as a system anomaly over the time-span in question. In another example, one or more selected key performance metrics may drop below a lower threshold for the duration of the time span. For these examples, the upper and lower thresholds may correspond to normal limits of operation for the large scale distributed system over the time span in question. This type of example can be illustrated by graphs, which will be described below.

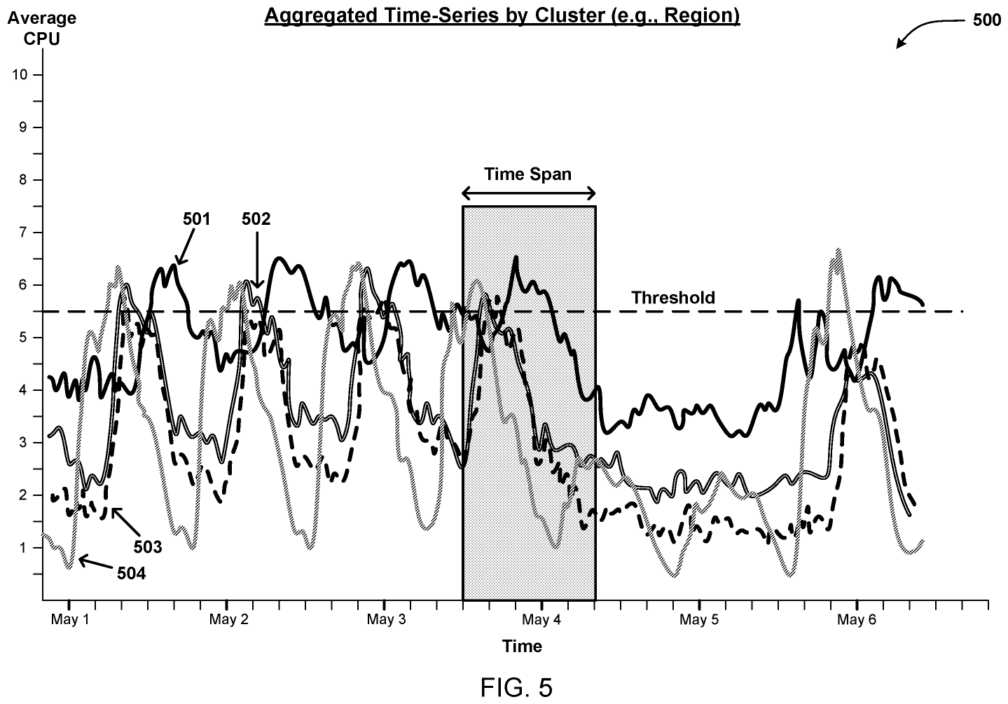

FIG. 5 is a graph 500 demonstrating various aspects of aggregated time-series employed by example diagnostics modules, in accordance with various aspects described herein. Graph 500 illustrates the average CPU usage (on a sale from 1 to 10) as an example of a system resource that may be monitored for multivariate analysis. Four different clusters are illustrated, as numbered 501, 502, 503 and 504. Each of the clusters may correspond to different geographic region associated with the monitored resource. For example, 501 may illustrate CPU usage in a North US region, 502 may illustrate CPU usage in a South US region, 503 may illustrate CPU usage in an East US region, and 504 may illustrate CPU usage in a West US region.

As shown, CPU usage for each individual cluster changes overtime, e.g., moment-by-moment, hourly, daily, etc. The CPU usage may be within a normal operating range of say 0 to 5.5 for this example, with a threshold for anomaly detection being at 5.5. When the system resource usage for a given cluster exceeds the threshold for a sufficient duration (e.g., over the time span), then an anomaly may be detected as outside of the normal operating range. For the illustrated example, an anomaly may not be detected since the threshold of the monitored metric is not exceeded for a sufficient duration. However, this is merely one example, and the time-spans of interest and threshold conditions may vary based on other criteria that requires additional domain expertise.

### Experimental Results

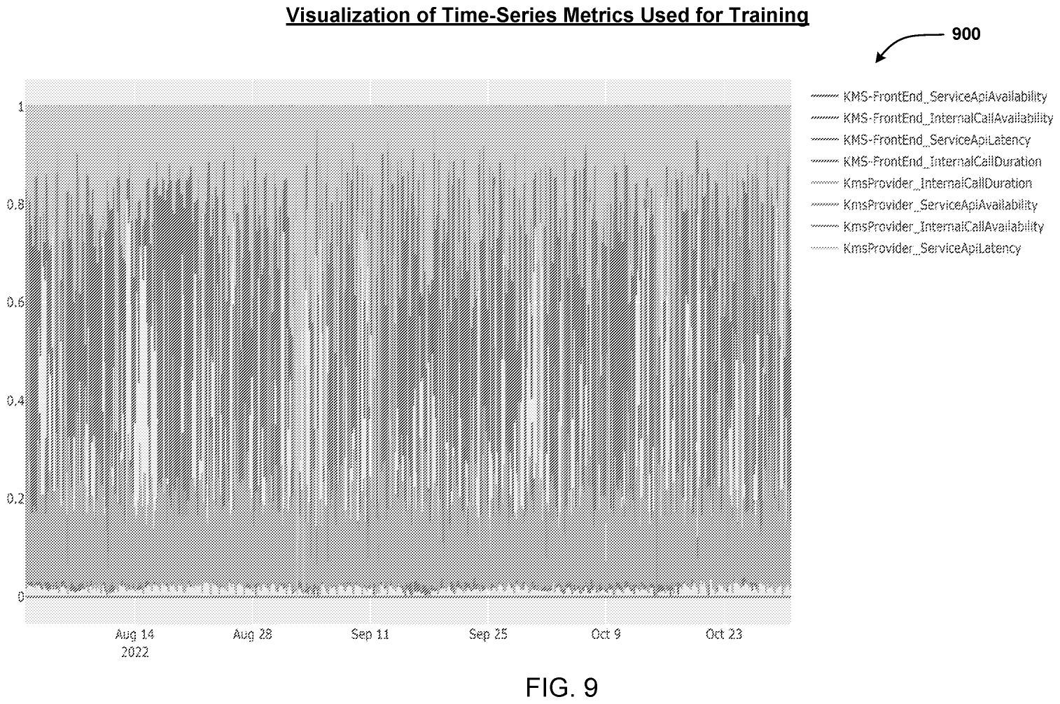

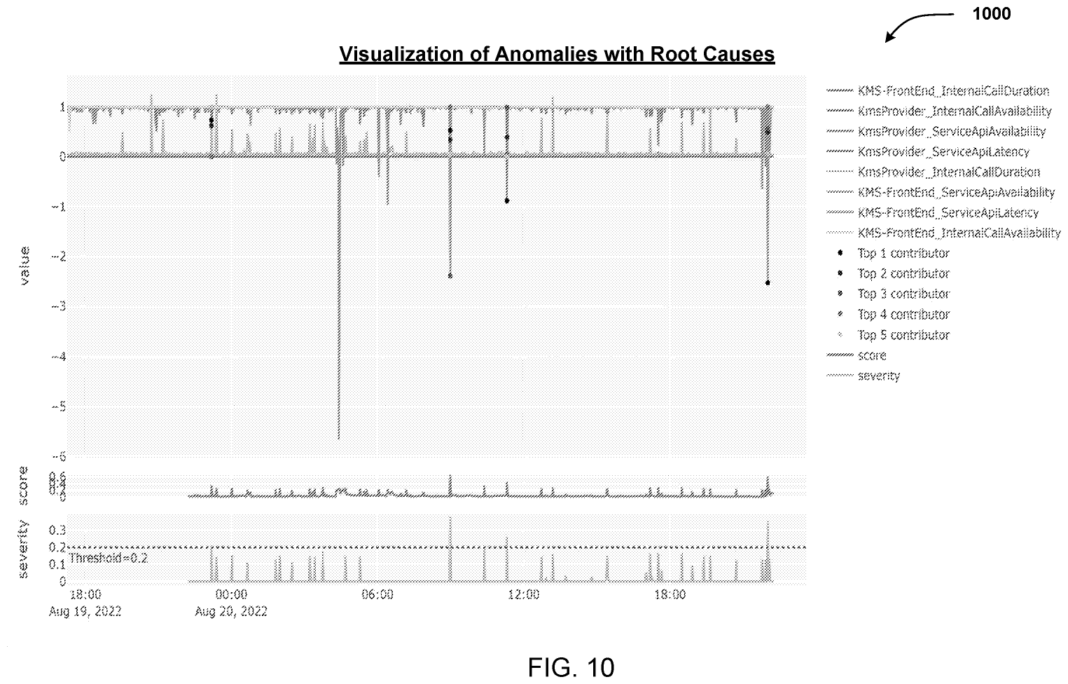

The presently disclosed two-tier approach of anomaly detection is currently being explored an experimented with by the Microsoft Security organization for an extended term of six months. While under constant monitoring, anomalies and their causes are being tracked within services and their dependencies. The presently described diagnostics module has a precision of about 90% and a recall of about 77.5%. Additional data has shown that the diagnostics module is able to detect anomalies by reducing the Time to Detect on an average by 15 minutes, which is a 75% improvement from previous detection methods. The diagnostics module has also been able to pinpoint the top contributors of root causes with weighting of 46% for one metric and 22% for another metric, which allowed to reduce the Time to Mitigate by about an hour. These results are illustrated in FIGS. 9 and 10.

### Prognostics

It is essential for cloud providers to provide services that are both highly available and reliable. To achieve these goals, the provide ensure that the provided services can function without impacting customers even if some components within the services are degraded. Currently, customers of many cloud services face outages when some components of the system face an issue and there exists a gap between the detection of the issue and the implementation of a solution. This gap can result in significant downtime, data loss, and financial losses for customers. The usual cause for these gaps can be due to the time it takes for an engineer or support team to identify, investigate, and implement an appropriate solution for the issue. To reduce or prevent this gap in service, an ML aided solution is employed by the present prognostics module 140, which that can resolve issues before there is an impact or with minimal impact on customers.

Referring back to FIGS. 1 and 2, the implementation of the prognostic module or component 140, can include functionality for rule mappings 142, ranking 144, execution 146 and verification 148. A knowledge base 150 may also be leveraged by the prognostics module, where the knowledge base may include troubleshooting guides (TSG, 152), whitepapers, FAQs and other internet based resources 154. In some examples, the prognostics component 140 may also leverage skills and resources of AI 120 as will be further described below.

As previously described, the diagnostics module 130 identifies and predicts degradations in the system, which are detailed in diagnostic incident reports. These diagnostic incident reports may be provided to the prognostics module 140 as a starting point. Prognostics work then involves providing a mapping of faults or incidents to recommendations and resolution plans to drive to recovery and resolution.

In a basic implementation of the prognostics module 140, key information associated with diagnostic incident reports are identified and applied in a rule-based mapping topology that maps issue types to a resolution plan. The resolution plan can be executed as the necessary steps to automatically mitigate or resolve the incidents. This approach can significantly reduce the time it takes to resolve frequently occurring issues/degradations in an automated fashion. Execution of the steps can be performed by engineering or support teams, or done via automation depending on the complexity of the resolution plan. In some examples, an ML based AI support component that is trained in the correct domain may be leveraged to assist or perform the executed steps towards resolution.

In one example of an AI assisted prognostics module 140, the prognostics module 140 may leverage an ML based AI support component that is trained in the correct domain to analyze the diagnostic incident reports. Trouble Shooting Guides (TSGs) can be reviewed by the AI for possible relevance to the incident, and ranked in order of highest to lowest relevance. For any given incident, the top-ranking TSGs may then be reviewed by the engineer or support team, and evaluated for possible applicability. Optionally, the engineer or support team may also collect feedback for the ML system regarding the applicability of each selected TSG so that the ML model can be constantly tuned to provide more accurate TSGs for future incidents.

In an advanced example of an AI assisted prognostics module 140, a Large Language Models such as GPT-4 can be leveraged to provide multiple levels of necessary troubleshooting and engineering support. For this example, the ML based models can be tuned with specific domain knowledge, using few-shot learning with the TSG knowledge base. This enables the AI assisted support system to perform better with the task of proposing TSGs. Once fully trained in the domain, the LLM may be used to generate new TSGs for issues that do not already have a TSG with a strong relevance score and propose the generated TSGs as a resolution plan for the engineer to review and execute while obtaining feedback on the same. Similar to the previous examples, once a high degree of confidence is achieved for both existing and generated TSGs, the AI support system may be configured to execute the steps outlined in the resolution plan automatically, and thus speeding the resolution of the issue identified in the diagnostic incident report.

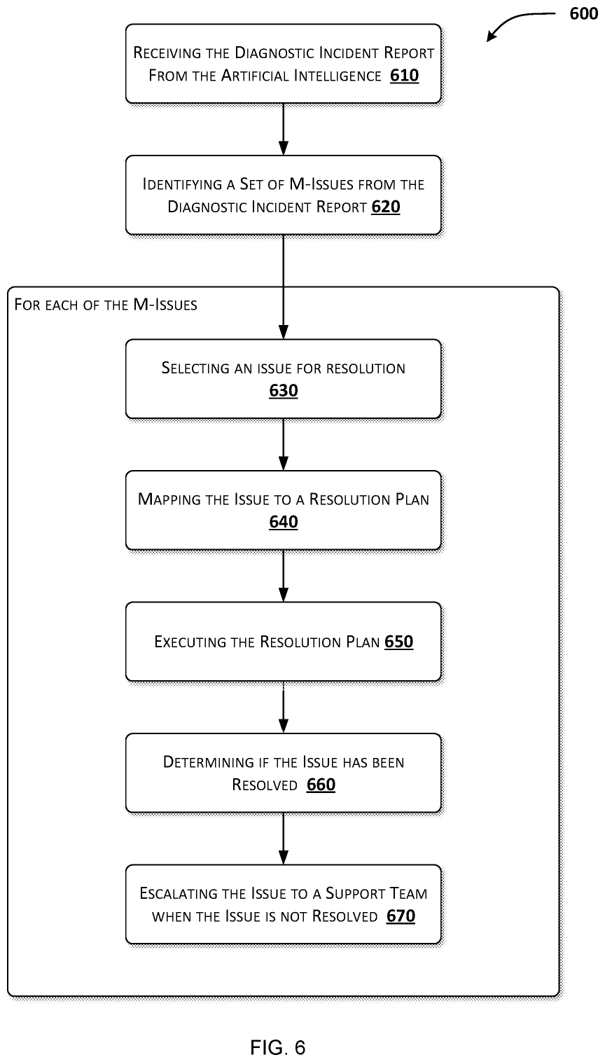

FIG. 6 is an example flow diagram 600 for a prognostics module 140 of an example system (e.g., 100, 200, etc.), arranged in accordance with various aspects described herein. The flow diagram 600 may be broken into various blocks or partitions, such as blocks 610, 620, 630, 640, 650 and 660, as illustrated. Processing for the various blocks of flow diagram 600, which may be described as processes, methods, steps, or functions, may commence at block 610.

At block 610, “Receiving the Diagnostic Incident Report from the Artificial Intelligence”, the prognostics module or component 140 receives the diagnostic incident report and details previously described with respect the diagnostic module 130. Processing continues from block 610 to block 620.

At block 620, “Identifying a Set of M-Issues from the Diagnostic Incident Report”, a set of M-issues are identified by the prognostics component from the diagnostic incident report. Processing continues from block 620 to block 630.

At block 630, “Selecting an Issue for Resolution”, each of the M-issues are selected for processing. In one example, an iterative loop such as a for loop (e.g., for each of the M-issues . . . ) may be used to process each of the issues one at a time. In other examples, one or more of the issues may be processed in parallel with one another. In another example, one or more of the issues are sent to a service handler for processing. These are merely non-limiting examples, and other possibilities for handling the selection and processing of issues are contemplated. Block 630 is followed by block 640.

At block 640, “Mapping the Issue to a Resolution Plan”, the currently selected issue identified at block 530 can be mapped to a resolution plan. The resolution plan may include one or more steps to be taken (either by a human operator or an automated system) in an attempt to resolve the selected issue. In some examples, the mapping of the issue to the resolution plan may include applying a rule based mapping, such as based on an issue type that is relevant to both the selected issue and the proposed resolution plan. In some additional examples, the issue may be mapped to the resolution plan by retrieving one or more troubleshooting guides with the machine learning based artificial intelligence support system based on the selected issue. Processing continues from block 640 to block 650.

In some other examples, mapping the issue to the resolution plan includes automated selection of troubleshooting guides by the machine learning based artificial intelligence support system based on the selected issue. The automated selection of troubleshooting guides may comprise one or more of: identification of existing troubleshooting guides from a knowledge base, or generation of new troubleshooting guides from the knowledge base by the machine learning based artificial intelligence support system based on the selected issue. The knowledge base may include one or more of: internet based searches, FAQs, technical articles, and other skills and resources of the machine learning based artificial intelligence support system based on the selected issue.

At block 650, “Executing the Resolution Plan”, the resolution plan selected at block 640 is reviewed and executed in an attempt to resolve the issue previously identified by the incident report. In some examples, executing the resolution plan may include providing the retrieved troubleshooting guides to the support team for execution. In other examples, executing the resolution plan may include automated execution of steps in the retrieved troubleshooting guides by the machine learning based artificial intelligence support system. Processing continues from block 650 to block 660.

At block 660, “Determining if the Issue has been Resolved”, the prognostics module may determine if the issue identified by the diagnostic incident report has been resolved. In some examples, issue resolution is determined as resolved by an operator such as an engineer or support team member. In other examples, the prognostics system may communicate with AI support system and/or the diagnostics module to determine if the issue has been resolved. In still other examples, the prognostics system may query other tools or resources to assess if the issue has been resolved. Processing continues from block 660 to block 670.

At block 670, “Escalating the Issue to a Support Team when the Issue is not Resolved”, prognostics component 140 may escalate unresolved issues to an engineer, support team, or in some instances a higher level support team.

### ML Training

Machine learning (ML) training is a process where an ML model is trained on a large dataset to learn patterns, relationships, desired outcomes, and other representations from the dataset. The ML model uses these learned patterns to make predictions or decisions on new, unseen data. There are several key steps in the ML training process, including data thresholding, data labelling, and word embeddings.

Data Thresholding: Data thresholding is a process of filtering out data that does not meet certain criteria. This can involve setting thresholds on certain attributes or features of the data to include or exclude data points based on predefined conditions. In the context of anomaly detection, thresholding is an important criteria to set minimum, maximum, and normal operating ranges for key performance indicators of the large scale distributed system. Data thresholding helps to ensure that the training dataset used for the ML model is of sufficient quality and meets the desired criteria.

Data Labelling: Data labelling is the process of assigning labels or annotations to data points in a dataset to note important relationship and to serve as vetted examples or reference points for the ML model during training. For example, in a supervised classification of data associated with known anomalies, data labelling may involve assigning labels to the data points, indicating the correct category or type of anomaly or system performance indictor to which they belong. Data labelling can be a crucial step in ML training as it provides the model with guided examples to learn from and enables the ML system to make predictions on previously unseen data.

Word Embeddings: Word embeddings are a type of representation that transforms words or text data into continuous, numerical vectors that capture semantic meaning. Word embeddings can be used to represent words or text data as points in a high-dimensional vector space, where similar words or phrases are represented by vectors that are close to each other in the vector space. ML systems can be improved by capturing semantic meaning and relationships between words, which can help in tasks such as text classification, sentiment analysis, and natural language processing. By using word embeddings in a training set for the present diagnostic system, the ML models can learn more meaningful representations of text data, and make better correlation between the text data and issue identification for anomalies.

In summary, data thresholding, data labelling, and word embeddings are important techniques used in the ML training process to improve the quality of training data and the representation of input data. These techniques help in training ML models with better accuracy, performance, and generalization capabilities.

The presently disclosed systems can use these above described techniques to improve the training for diagnostics and prognostics. For example, the multivariate anomaly detection model used by the diagnostics module is trained on the normal behavior of metric data; where the dataset for “Normal Behavior” can be derived from customer inputs non-anomalous behavior of the instant systems during. An onboarding UI can be used to facilitate setting up metrics for monitoring, labeling of data, and manually triggering incidents based on the selected metrics. Thus, faults can be injected into the system and labels automatically generated for those injected faults to streamline training.

The raw data values may include both “Normal” and “Faulty” behaviors. The multivariate anomaly detection model, however, must typically be trained on normal behavior so it can accurately detect anomalies during inference. For a newly deployed large scale distributed system, the necessary information to distinguish between the system's normal and faulty behaviors may be unknown. Hence, domain specific subject matter expertise may be further required to remove existing outliers during training. Upper and lower thresholds should be determined for each metric so that the information can be preprocessed into the training data, and anomalies should ideally be removed from the data set.

Thresholding might be too complicated a process to generalize for all metrics. For example, an APIDuration metric such as API1 might take 6 seconds on an average whereas API2 might take only 200 ms. Thus, an anomaly in the duration metric for API2 might not be an anomaly for API1, making it hard to come to a single threshold for a specific metric. Dimensional filtering provides a mechanism to choose the specific values from a given dimension to build into models. Instead of aggregating only based on a single criteria such as a region value, the dimension filter can also be considered as part of the key value pair. For example, the APIDuration time series can be split into two time series, (1) APIDuration_API1, and (2) APIDuration_API2. Since the time series is split, it is now possible to assign separate thresholds to each of the time series.

Although metrics are described as being used to determine and train for anomaly detection, the system implementation is not so limited. Any telemetry and event data described herein is equally applicable, where patterns can be detected and recognized from historical data training, thresholding, labelling, and dimensional filtering.

The particular implementation of the technologies disclosed herein is a matter of choice dependent on the performance and other requirements of a computing device. Accordingly, the logical operations described herein are referred to variously as states, operations, structural devices, acts, modules, or components. These states, operations, structural devices, acts, modules, or components can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

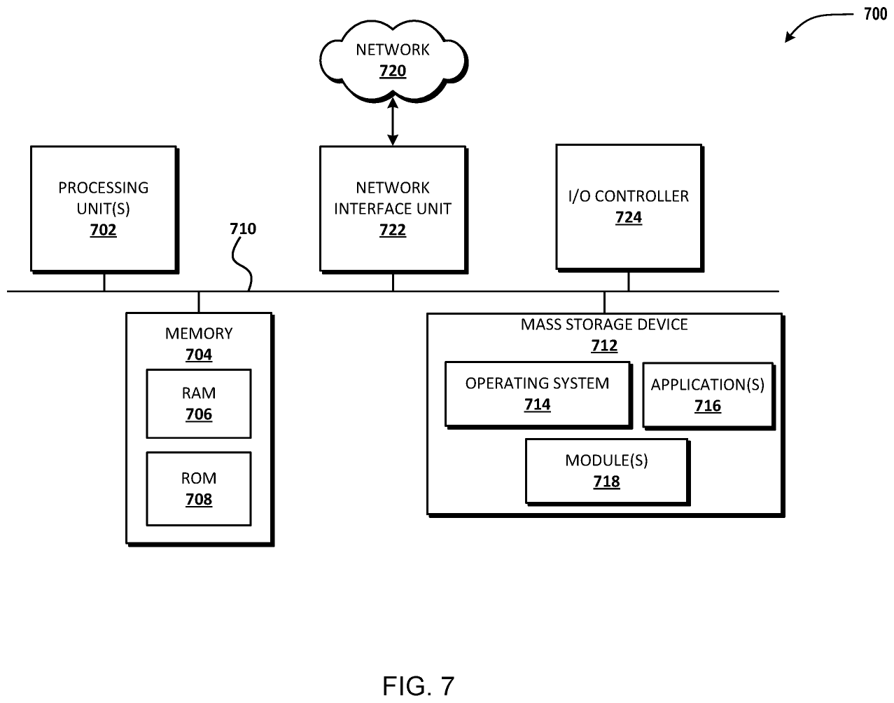

FIG. 7 shows additional details of an example computer architecture 700 for a device, such as a computer or a server configured as part of the systems (e.g., 100, 200, etc.) described herein, capable of executing computer instructions (e.g., a module or a program component described herein). The computer architecture 700 illustrated in FIG. 7 includes processing unit(s) 702, a system memory 704, including a random-access memory 706 (“RAM”) and a read-only memory (“ROM”) 708, and a system bus 710 that couples the memory 704 to the processing unit(s) 702.

Processing unit(s) or processor(s), such as processing unit(s) 702, can represent, for example, a CPU-type processing unit, a GPU-type processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 700, such as during startup, is stored in the ROM 708. The computer architecture 700 further includes a mass storage device 712 for storing an operating system 714, application(s) 716, modules 718, and other data described herein.

The mass storage device 712 is connected to processing unit(s) 702 through a mass storage controller connected to the bus 710. The mass storage device 712 and its associated computer-readable media provide non-volatile storage for the computer architecture 700. Although the description of computer-readable media contained herein refers to a mass storage device, it should be appreciated by those skilled in the art that computer-readable media can be any available computer-readable storage media or communication media that can be accessed by the computer architecture 700.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 700 may operate in a networked environment using logical connections to remote computers through the network 720. The computer architecture 700 may connect to the network 720 through a network interface unit 722 connected to the bus 710. The computer architecture 700 also may include an input/output controller 724 for receiving and processing input from a number of other devices, including a keyboard, mouse, touch, or electronic stylus or pen. Similarly, the input/output controller 724 may provide output to a display screen, a printer, or other type of output device.

It should be appreciated that the software components described herein may, when loaded into the processing unit(s) 702 and executed, transform the processing unit(s) 702 and the overall computer architecture 700 from a general-purpose computing system into a special-purpose computing system customized to facilitate the functionality presented herein. The processing unit(s) 702 may be constructed from any number of transistors or other discrete circuit elements, which may individually or collectively assume any number of states. More specifically, the processing unit(s) 702 may operate as a finite-state machine, in response to executable instructions contained within the software modules disclosed herein. These computer-executable instructions may transform the processing unit(s) 702 by specifying how the processing unit(s) 702 transition between states, thereby transforming the transistors or other discrete hardware elements constituting the processing unit(s) 702.

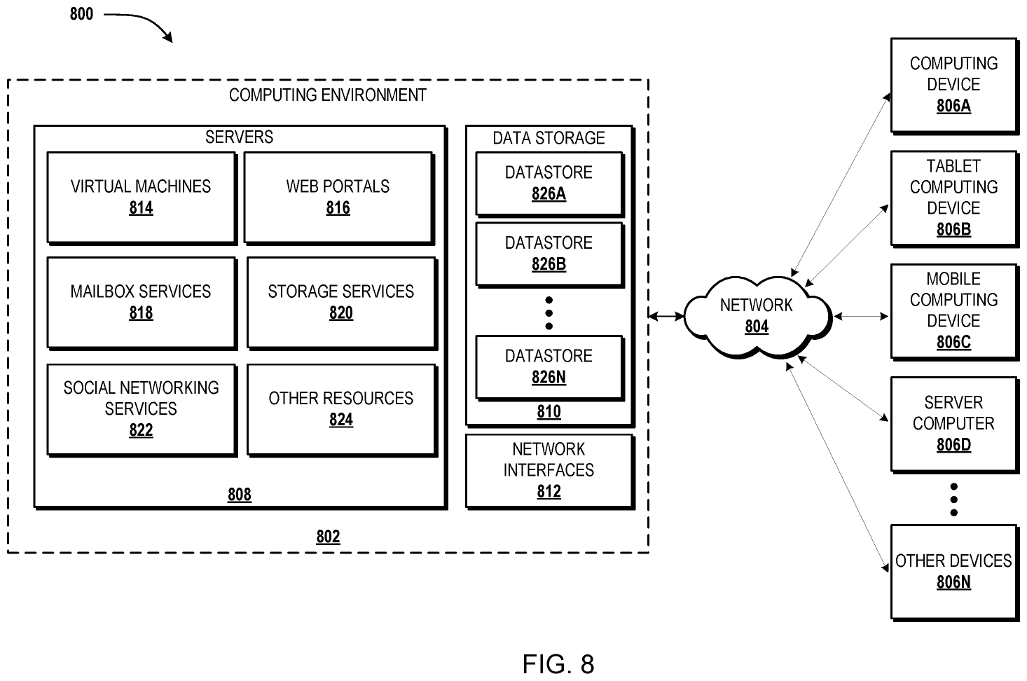

FIG. 8 depicts an illustrative distributed computing environment 800 capable of executing the software components described herein. Thus, the distributed computing environment 800 illustrated in FIG. 8 can be utilized to execute any aspects of the software components presented herein. For example, the distributed computing environment 800 can be utilized to execute aspects of the software components described herein.

Accordingly, the distributed computing environment 800 can include a computing environment 802 operating on, in communication with, or as part of the network 804. The network 804 can include various access networks. One or more client devices 806A-806N (hereinafter referred to collectively and/or generically as “clients 806” and also referred to herein as computing devices 806) can communicate with the computing environment 802 via the network 804. In one illustrated configuration, the clients 806 include a computing device 806A such as a laptop computer, a desktop computer, or other computing device; a slate or tablet computing device (“tablet computing device”) 806B; a mobile computing device 806C such as a mobile telephone, a smart phone, or other mobile computing device; a server computer 806D; and/or other devices 806N. It should be understood that any number of clients 806 can communicate with the computing environment 802.

In various examples, the computing environment 802 includes servers 808, data storage 810, and one or more network interfaces 812. The servers 808 can host various services, virtual machines, portals, and/or other resources. In the illustrated configuration, the servers 808 host virtual machines 814, Web portals 816, mailbox services 818, storage services 820, and/or, social networking services 822. As shown in FIG. 8 the servers 808 also can host other services, applications, portals, and/or other resources (“other resources”) 824.

As mentioned above, the computing environment 802 can include the data storage 810. According to various implementations, the functionality of the data storage 810 is provided by one or more databases operating on, or in communication with, the network 804. The functionality of the data storage 810 also can be provided by one or more servers configured to host data for the computing environment 802. The data storage 810 can include, host, or provide one or more real or virtual datastores 826A-826N (hereinafter referred to collectively and/or generically as “datastores 826”). The datastores 826 are configured to host data used or created by the servers 808 and/or other data. That is, the datastores 826 also can host or store web page documents, word documents, presentation documents, data structures, algorithms for execution by a recommendation engine, and/or other data utilized by any application program. Aspects of the datastores 826 may be associated with a service for storing files.

The computing environment 802 can communicate with, or be accessed by, the network interfaces 812. The network interfaces 812 can include various types of network hardware and software for supporting communications between two or more computing devices including, but not limited to, the computing devices and the servers. It should be appreciated that the network interfaces 812 also may be utilized to connect to other types of networks and/or computer systems.

It should be understood that the distributed computing environment 800 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 800 provides the software functionality described herein as a service to the computing devices.

It should be understood that the computing devices can include real or virtual machines including, but not limited to, server computers, web servers, personal computers, mobile computing devices, smart phones, and/or other devices. As such, various configurations of the concepts and technologies disclosed herein enable any device configured to access the distributed computing environment 800 to utilize the functionality described herein for providing the techniques disclosed herein, among other aspects.

The present disclosure is supplemented by the following example clauses:

Example 1: A method for a support system to service a large scale distributed system, the method comprising: collecting multivariate telemetry and event data by a diagnostics component of the support system; analyzing the multivariate telemetry and event data by multivariate analysis to identify a set of N-anomalies with the diagnostics component of the support system; for each of the set of N-anomalies: obtaining unaggregated univariate telemetry and event data by the diagnostics component of the support system; and analyzing the unaggregated univariate telemetry and event data by univariate analysis by the diagnostics component of the support system; ranking the diagnostic results of the univariate analysis by the diagnostics component of the support system; providing the diagnostic results and rankings to the machine learning (ML) based artificial intelligence (AI) support component, and receiving a diagnostic incident report from the ML based AI support component.

Example 2: The method of Example 1, wherein collecting multivariate telemetry and event data comprises collecting one or more of: performance metrics associated with the large scale distributed system; logs associated with the large scale distributed system; and change events associated with the large scale distributed system.

Example 3: The method of Example 1, wherein collecting multivariate telemetry and event data comprises collecting metrics associated with a cluster of resources.

Example 4: The method of Example 3, wherein the cluster is segmented by region.

Example 5: The method of Example 1, wherein analyzing the multivariate telemetry and event data comprises: segmenting the multivariate telemetry and event data into clusters; selecting one of the clusters: selecting one or more key performance metrics for the selected cluster; monitoring the one or more selected key performance metrics over a time span for the selected cluster; and identifying an anomaly for the selected cluster when one or more of the selected key performance metrics exceeds a pre-determined threshold.

Example 6: The method of Example 5, wherein identifying the anomaly for the selected cluster further comprises one of: detecting the anomaly when the one or more selected key performance metrics is above an upper threshold for a duration of the time span, or detecting the anomaly when the one or more selected key performance metrics is below a lower threshold for the duration of the time span, wherein the upper and lower thresholds correspond to normal limits of operation for the large scale distributed system.

Example 7: The method of Example 1, further comprising: receiving the diagnostic incident report by a prognostics component of the support system; identifying a set of M-issues from the diagnostic incident report by the prognostics component of the support system; selecting one of the M-issues for resolution; for the selected one of the M-issues: mapping the issue to a resolution plan; executing the resolution plan; determining if the issue has been resolved by executing the resolution plan; and escalating the issue to a support team when the issue is not resolved.

Example 8: The method of Example 7, wherein mapping the issue to the resolution plan comprises applying a rule based mapping based between an issue type identified with the selected issue and the resolution plan.

Example 9: The method of Example 7, wherein mapping the issue to the resolution plan comprises retrieving one or more troubleshooting guides with the machine learning (ML) based artificial intelligence (AI) support component based on the selected issue.

Example 10: The method of Example 9, wherein executing the resolution plan comprises one of providing the retrieved troubleshooting guides to the support team for execution, and automated execution of steps in the retrieved troubleshooting guides by the machine learning (ML) based artificial intelligence (AI) support component.

Example 11: The method of Example 7, wherein mapping the issue to the resolution plan comprises automated selection of troubleshooting guides by the machine learning (ML) based (AI) artificial intelligence support component based on the selected issue.

Example 12: The method of Example 11, wherein automated selection of troubleshooting guides comprises one or more of: identification of existing troubleshooting guides from a knowledge base, or generation of new troubleshooting guides from the knowledge base by the machine learning (ML) based artificial intelligence (AI) support component based on the selected issue.

Example 13: The method of Example 12, wherein the knowledge base includes one or more of: internet based searches, FAQs, technical articles, and other skills and resources of the machine learning (ML) based artificial intelligence (AI) support component based on the selected issue.

Example 14: A computer-readable storage medium having computer-executable instructions stored thereupon that, when executed by one or more processing units of a support system to service a large scale distributed system, cause the support system to: collect multivariate telemetry and event data by a diagnostics component of the support system; analyze the multivariate telemetry and event data by multivariate analysis to identify a set of N-anomalies with the diagnostics component of the support system; for each of the set of N-anomalies: obtain unaggregated univariate telemetry and event data by the diagnostics component of the support system; and analyze the unaggregated univariate telemetry and event data by univariate analysis by the diagnostics component of the support system; rank the diagnostic results of the univariate analysis by the diagnostics component of the support system; provide the diagnostic results and rankings to the machine learning (ML) based artificial intelligence (AI) support component, and receive a diagnostic incident report from the ML based AI support component.

Example 15: The computer-readable storage medium of Example 14, wherein the computer-executable instructions stored thereupon, when executed by one or more processing units of the support system, further cause the support system to: segment the multivariate telemetry and event data into clusters; select one of the clusters: select one or more key performance metrics for the selected cluster; monitor the one or more selected key performance metrics over a time span for the selected cluster; and identify an anomaly for the selected cluster when one or more of the selected key performance metrics exceeds a pre-determined threshold.

Example 16: The computer-readable storage medium of Example 14, wherein the computer-executable instructions stored thereupon, when executed by one or more processing units of the support system, further cause the support system to: receive the diagnostic incident report by a prognostics component of the support system; identify a set of M-issues from the diagnostic incident report by the prognostics component of the support system; select one of the M-issues for resolution; for the selected one of the M-issues: map the issue to a resolution plan; execute the resolution plan; determine if the issue has been resolved by executing the resolution plan; and escalate the issue to a support team when the issue is not resolved.

Example 17: A support system to service a large scale distributed system, the support system comprising: a processor; and a computer-readable storage medium having computer-executable instructions stored thereupon that, when executed by the processor, cause the support system to: collect multivariate telemetry and event data by a diagnostics component of the support system; analyze the multivariate telemetry and event data by multivariate analysis to identify a set of N-anomalies with the diagnostics component of the support system; for each of the set of N-anomalies: obtain unaggregated univariate telemetry and event data by the diagnostics component of the support system; and analyze the unaggregated univariate telemetry and event data by univariate analysis by the diagnostics component of the support system; rank the diagnostic results of the univariate analysis by the diagnostics component of the support system; provide the diagnostic results and rankings to the machine learning (ML) based artificial intelligence (AI) support component; and receive a diagnostic incident report from the ML based AI support component.

Example 18. The system of Example 17, wherein the computer-readable storage medium having computer-executable instructions stored thereupon, when executed by the processor, further cause the support system to: segment the multivariate telemetry and event data into clusters; select one of the clusters: select one or more key performance metrics for the selected cluster; monitor the one or more selected key performance metrics over a time span for the selected cluster; and identify an anomaly for the selected cluster when one or more of the selected key performance metrics exceeds a pre-determined threshold.

Example 19: The system of Example 17, wherein the computer-readable storage medium of having computer-executable instructions stored thereupon, when executed by the processor, further cause the support system to: receive the diagnostic incident report by a prognostics component of the support system; identify a set of M-issues from the diagnostic incident report by the prognostics component of the support system; select one of the M-issues for resolution; for the selected one of the M-issues: map the issue to a resolution plan; execute the resolution plan; determine if the issue has been resolved by executing the resolution plan; and escalate the issue to a support team when the issue is not resolved.

Example 20: The system of Example 19, wherein the computer-readable storage medium of having computer-executable instructions stored thereupon, when executed by the processor, further cause the support system to: selectively map the issue to the resolution plan by automated selection of troubleshooting guides with the machine learning based artificial intelligence support system based on the selected issue; wherein automated selection of troubleshooting guides comprises one or more of: identification of existing troubleshooting guides from a knowledge base, or generation of new troubleshooting guides from the knowledge base by the machine learning based artificial intelligence support system based on the selected issue; and wherein the knowledge base includes one or more of internet based searches, FAQs, technical articles, and other skills and resources of the machine learning based artificial intelligence support system based on the selected issue.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method for support system to service a large scale distributed system, the method comprising:
collecting multivariate telemetry and event data by a diagnostics component of the support system;
analyzing the multivariate telemetry and event data by multivariate analysis to identify a set of N-anomalies with the diagnostics component of the support system;
for each of the set of N-anomalies:
obtaining unaggregated univariate telemetry and event data by the diagnostics component of the support system; and
analyzing the unaggregated univariate telemetry and event data by univariate analysis by the diagnostics component of the support system;
ranking the diagnostic results of the univariate analysis by the diagnostics component of the support system;
providing the diagnostic results and rankings to a machine learning (ML) based artificial intelligence (AI) support component; and
receiving a diagnostic incident report from the ML based AI support component.

2. The method of claim 1, wherein collecting multivariate telemetry and event data comprises collecting one or more of:
performance metrics associated with the large scale distributed system;
logs associated with the large scale distributed system; and
change events associated with the large scale distributed system.

3. The method of claim 1, wherein collecting multivariate telemetry and event data comprises collecting metrics associated with a cluster of resources.

4. The method of claim 3, wherein the cluster is segmented by region.

5. The method of claim 1, wherein analyzing the multivariate telemetry and event data comprises:
segmenting the multivariate telemetry and event data into clusters;
selecting one of the clusters:
selecting one or more key performance metrics for the selected cluster;
monitoring the one or more selected key performance metrics over a time span for the selected cluster; and
identifying an anomaly for the selected cluster when one or more of the selected key performance metrics exceeds a pre-determined threshold.

6. The method of claim 5, wherein identifying the anomaly for the selected cluster further comprises one of: detecting the anomaly when the one or more selected key performance metrics is above an upper threshold for a duration of the time span, or detecting the anomaly when the one or more selected key performance metrics is below a lower threshold for the duration of the time span, wherein the upper and lower thresholds correspond to normal limits of operation for the large scale distributed system.

7. The method of claim 1, further comprising:
receiving the diagnostic incident report by a prognostics component of the support system;
identifying a set of M-issues from the diagnostic incident report by the prognostics component of the support system;
selecting one of the M-issues for resolution;
for the selected one of the M-issues:
mapping the issue to a resolution plan;
executing the resolution plan;
determining if the issue has been resolved by executing the resolution plan; and
escalating the issue to a support team when the issue is not resolved.

8. The method of claim 7, wherein mapping the issue to the resolution plan comprises applying a rule based mapping based between an issue type identified with the selected issue and the resolution plan.

9. The method of claim 7, wherein mapping the issue to the resolution plan comprises retrieving one or more troubleshooting guides with the ML based AI support component based on the selected issue.

10. The method of claim 9, wherein executing the resolution plan comprises one of providing the retrieved troubleshooting guides to the support team for execution, and automated execution of steps in the retrieved troubleshooting guides by the machine learning based artificial intelligence support system.

11. The method of claim 7, wherein mapping the issue to the resolution plan comprises automated selection of troubleshooting guides by the ML based AI support component based on the selected issue.

12. The method of claim 11, wherein automated selection of troubleshooting guides comprises one or more of: identification of existing troubleshooting guides from a knowledge base, or generation of new troubleshooting guides from the knowledge base by the ML based AI support component based on the selected issue.

13. The method of claim 12, wherein the knowledge base includes one or more of: internet based searches, FAQs, technical articles, and other skills and resources of the ML based AI support component based on the selected issue.

14. A computer-readable storage medium having computer-executable instructions stored thereupon that, when executed by one or more processing units of a support system to service a large scale distributed system, cause the support system to:
collect multivariate telemetry and event data by a diagnostics component of the support system;
analyze the multivariate telemetry and event data by multivariate analysis to identify a set of N-anomalies with the diagnostics component of the support system;
for each of the set of N-anomalies:
obtain unaggregated univariate telemetry and event data by the diagnostics component of the support system; and
analyze the unaggregated univariate telemetry and event data by univariate analysis by the diagnostics component of the support system;
rank the diagnostic results of the univariate analysis by the diagnostics component of the support system;
provide the diagnostic results and rankings to the machine learning (ML) based artificial intelligence (AI) support component; and
receive a diagnostic incident report from the ML based AI support component.

15. The computer-readable storage medium of claim 14, wherein the computer-executable instructions stored thereupon, when executed by one or more processing units of the support system, further cause the support system to:
segment the multivariate telemetry and event data into clusters;
select one of the clusters:
select one or more key performance metrics for the selected cluster;
monitor the one or more selected key performance metrics over a time span for the selected cluster; and
identify an anomaly for the selected cluster when one or more of the selected key performance metrics exceeds a pre-determined threshold.

16. The computer-readable storage medium of claim 14, wherein the computer-executable instructions stored thereupon, when executed by one or more processing units of the support system, further cause the support system to:
receive the diagnostic incident report by a prognostics component of the support system;
identify a set of M-issues from the diagnostic incident report by the prognostics component of the support system;
select one of the M-issues for resolution;
for the selected one of the M-issues:
map the issue to a resolution plan;
execute the resolution plan;
determine if the issue has been resolved by executing the resolution plan; and
escalate the issue to a support team when the issue is not resolved.

17. A support system to service a large scale distributed system, comprising:
a processor; and
a computer-readable storage medium having computer-executable instructions stored thereupon that, when executed by the processor, cause the support system to:
collect multivariate telemetry and event data by a diagnostics component of the support system;
analyze the multivariate telemetry and event data by multivariate analysis to identify a set of N-anomalies with the diagnostics component of the support system;
for each of the set of N-anomalies:
obtain unaggregated univariate telemetry and event data by the diagnostics component of the support system; and
analyze the unaggregated univariate telemetry and event data by univariate analysis by the diagnostics component of the support system;
rank the diagnostic results of the univariate analysis by the diagnostics component of the support system;
provide the diagnostic results and rankings to the machine learning (ML) based artificial intelligence (AI) support component; and
receive a diagnostic incident report from the ML based AI support component.

18. The system of claim 17, wherein the computer-readable storage medium having computer-executable instructions stored thereupon, when executed by the processor, further cause the support system to:
segment the multivariate telemetry and event data into clusters;
select one of the clusters:
select one or more key performance metrics for the selected cluster;
monitor the one or more selected key performance metrics over a time span for the selected cluster; and
identify an anomaly for the selected cluster when one or more of the selected key performance metrics exceeds a pre-determined threshold.

19. The system of claim 17, wherein the computer-readable storage medium of having computer-executable instructions stored thereupon, when executed by the processor, further cause the support system to:
receive the diagnostic incident report by a prognostics component of the support system;
identify a set of M-issues from the diagnostic incident report by the prognostics component of the support system;
select one of the M-issues for resolution;
for the selected one of the M-issues:
map the issue to a resolution plan;
execute the resolution plan;
determine if the issue has been resolved by executing the resolution plan; and
escalate the issue to a support team when the issue is not resolved.

20. The system of claim 19, wherein the computer-readable storage medium of having computer-executable instructions stored thereupon, when executed by the processor, further cause the support system to:
selectively map the issue to the resolution plan by automated selection of troubleshooting guides with the machine learning based artificial intelligence support system based on the selected issue;
wherein automated selection of troubleshooting guides comprises one or more of: identification of existing troubleshooting guides from a knowledge base, or generation of new troubleshooting guides from the knowledge base by the machine learning based artificial intelligence support system based on the selected issue; and
wherein the knowledge base includes one or more of internet based searches, FAQs, technical articles, and other skills and resources of the machine learning based artificial intelligence support system based on the selected issue.
